(19) United States
(12) Patent Application Publication
(10) Pub. No.: US 2009/0148366 A1
(43) Pub. Date: Jun. 11, 2009

(54) Magnesium Oxide Recovery

(76) Inventors: Eric Girvan Roche, Booragul (AU); Jaidev Prasad, Shortland (AU)

Correspondence Address: BRINKS HOFER GILSON & LIONE, P.O. BOX 10395, CHICAGO, IL, 60610, US

(21) Appl. No.: 12/142,280

(22) Filed: Jun. 19, 2008

Related U.S. Application Data
(63) Continuation of application No. PCT/AU2006/001983, filed on Jun. 28, 2007.

(30) Foreign Application Priority Data
Dec. 22, 2005 (AU) 2005907250

(51) Int. Cl. C01F 5/12

(52) U.S. Cl. 423/170

(57) ABSTRACT

A process of recovering magnesium oxide from a source of magnesium sulfate includes the steps of providing a source of magnesium sulfate in solution that is derived from part of a process that is associated with the leaching of a metal containing ore or concentrate; converting the magnesium sulfate in solution to solid magnesium sulfate; contacting the solid magnesium sulfate with elemental sulfur in a reducing atmosphere; and recovering the magnesium as magnesium oxide, and the sulfur as sulfur dioxide gas.

This application is a continuation of and claims priority from PCT/AU2006/001983 published in English on Jun. 28, 2007 as WO 2007/070973 and from AU 2005907250 filed Dec. 22, 2005, the entire contents of each are incorporated herein by reference.

### FIELD OF THE INVENTION

The present invention relates to a process for the recovery of magnesium oxide by reducing magnesium sulfate to magnesium oxide. The invention is particularly related to the recovery of magnesium oxide by contacting magnesium sulfate with elemental sulfur to reduce the magnesium sulfate to magnesium oxide.

The process is particularly applicable to the treatment of magnesium sulfate which may be recovered from a brine solution that has been produced during a process for the recovery of metal from a metal bearing ore or concentrate. It has particular application to the treatment of magnesium sulfate recovered from a brine solution associated with a nickel and cobalt recovery process that utilises sulfuric acid to leach nickel and cobalt from nickel and cobalt containing ores. The recovered magnesium oxide is of a high quality that makes it suitable for recirculation back into the nickel and cobalt recovery process. A by-product during the process is the production of sulfur dioxide gas, which can be utilised in the production of sulfuric acid, which can also be recirculated to the nickel and cobalt recovery process.

### BACKGROUND OF THE INVENTION

Magnesium oxide, or magnesia, is used relatively extensively in the mining industry, for example in hydrometallurgical refining processes for metal recovery. One particular use for magnesium oxide is as a neutralising agent to control the pH of acidic solutions. In nickel recovery processes, it is used to raise the pH of an acidic solution containing dissolved nickel and cobalt ions, to precipitate nickel and cobalt from acidic solutions as nickel and cobalt hydroxides.

One application of such a process is included within the Cawse project in Western Australia that recovers nickel and cobalt from laterite ores. The Cawse process, which is disclosed by White in AU701829, utilises solid magnesium oxide or freshly slurried magnesium oxide to precipitate dissolved nickel and cobalt from acidic solutions obtained from pressure acid leaching of laterite ores. The BHP Billiton Ravensthorpe project also proposes to recover nickel and cobalt as a mixed nickel and cobalt hydroxide product, as described by Miller et al, “Observations From the RNO Pilot Plant at Lakefield Research 2000 AD”, presented at ALTA 2001 Ni/Co-7 Conference, Scarborough, 15-18 May 2001.

Generally, good quality reactive magnesium oxide is not widely available and needs to be imported into a nickel refinery process, as is done in the Cawse project. This can add considerably to the cost of the nickel recovery process.

Laterite ores include both a high magnesium content saprolite component, and a low magnesium content limonite component. In commercial processes such as the Cawse process, nickel and cobalt are recovered from laterite ore by high-pressure acid leach processes where the nickel and cobalt are leached from the ore with sulfuric acid and precipitated as a mixed hydroxide following the addition of magnesium oxide.

Other non-commercial processes have been described where a mixed hydroxide precipitate is produced following the addition of a neutralising agent in an atmospheric pressure acid leach, or a combination of high pressure and atmospheric pressure leach process, or a heap leaching of the laterite ores. An example of such a process is disclosed by Liu in WO03/093517.

During such nickel recovery processes, magnesium values contained in the saprolitic silicates of nickel containing laterite ores are generally discarded as waste. The magnesium solubilised from the magnesium oxide used in the process is also discarded as waste. The dissolved magnesium generally reports to brine ponds associated with the refinery as magnesium sulfate or magnesium chloride brine.

The brine pond material is generally regarded as a waste product of the process. Metal values in the rejects material are lost when discarded as tailings and may also cause environmental concerns.

The present invention aims to provide a new process where magnesium oxide, of sufficient quality to be used in nickel and cobalt recovery processes can be recovered from magnesium sulfate contained within a brine solution.

Three U.S. patents, namely U.S. Pat. No. 4,781,903, U.S. Pat. No. 4,855,117 and U.S. Pat. No. 4,725,417, each in the name of Institut Français du Pétrole describe methods for the removal of sulfur oxides, particularly sulfur dioxide from gas streams. In each of these documents, a solid absorbent containing 1-50% by weight of magnesium oxide is used to fix the sulfur dioxide within the gas stream, the magnesium oxide being converted to magnesium sulfate in the process. The solid absorbent containing the magnesium oxide is then regenerated by contacting the magnesium sulfate with either a gas stream containing elemental sulfur or hydrogen sulfide to regenerate the magnesium oxide absorbent with sulfur dioxide produced as an effluent gas. However, the processes described in these documents would not produce a magnesium oxide product of sufficient quality for use as a neutralising agent in mineral processing operations. Furthermore the substantially quantitative conversion of magnesium sulfate to a high purity MgO product capable of being used for neutralisation of acid and precipitation of metals is not disclosed in these methods.

The present invention aims to overcome or at least alleviate one or more of the problems associated with the need to send potentially useful magnesium to brine ponds during metal recovery processes. The present invention further aims to provide an economic source of good quality magnesium oxide for use in metal recovery processes.

The above discussion of prior processes is included in the specification solely for the purpose of providing a context for the present invention. It is not suggested or represented that these processes formed part of the prior art base or the common general knowledge in the field relevant to the present invention before the priority date.

### SUMMARY OF THE INVENTION

The present invention relates to a process for the recovery of magnesium oxide from a source that contains magnesium sulfate. Generally the source of magnesium sulfate is the discarded solution in a process to recover metal from a metal bearing ore or concentrate, but the process is particularly applicable to the treatment of discarded solution in a nickel and cobalt recovery process, where sulfuric acid has been used to leach nickel and cobalt containing ores. In the process of the invention, magnesium oxide is recovered by contacting solid magnesium sulfate with elemental sulfur in a reducing atmosphere to produce the magnesium oxide. Sulfur dioxide gas is also produced during the reduction process, which may be used for other purposes, but is particularly useful in the production of sulfuric acid.

The process of the present invention is particularly applicable to treatment of a brine which is derived from a nickel and cobalt processing refinery, wherein the brine includes dissolved magnesium sulfate. The applicants have found that the magnesium sulfate can be converted to useful magnesium oxide by recovering the magnesium sulfate as a solid and contacting the solid magnesium sulfate with elemental sulfur in a reducing atmosphere to produce magnesium oxide and sulfur dioxide gas.

Accordingly, the present invention resides in a process of recovering magnesium oxide from a source of magnesium sulfate, said process including the steps of:
(a) providing a source of magnesium sulfate in solution that is derived from part of a process that is associated with the leaching of a metal containing ore or concentrate;
(b) converting the magnesium sulfate in solution to solid magnesium sulfate;
(c) contacting the solid magnesium sulfate with elemental sulfur in a reducing atmosphere; and
(d) recovering the magnesium as magnesium oxide, and the sulfur as sulfur dioxide gas.

It is most preferred that the source of magnesium sulfate in solution is derived from part of a nickel and cobalt recovery process that utilises acid to leach nickel and cobalt containing ores, most preferably the process is applicable to the use of sulfuric acid to leach nickel and cobalt containing ore.

Whereas the invention is particularly applicable to a process that utilises ulfuric acid to leach nickel and cobalt containing laterite ores, in particular the leaching of the high magnesium content saprolite component of laterite ores, it may also be applicable to other leaching processes such as the oxidative acid leaching of nickel containing sulfide ores or concentrates, or processes that involve the ammoniacal leaching of laterite ores or combined ammoniacal/acid leaching of ores. In each of these processes, there is generally a quantity of magnesium sulfate that may report to the waste ponds, due to the inherent content of magnesium and sulfur within the ore, or magnesium and sulfur that is introduced during the leach process.

### BRIEF DESCRIPTION OF THE DRAWINGS

FIG. 1 illustrates a flowsheet of a nickel and cobalt recovery process where magnesium sulfate from a brine pond is reduced to magnesium oxide with sulfur dioxide gas produced as a by-product. The magnesium oxide is usefully recirculated to the nickel and cobalt recovery process while the sulfur dioxide gas is converted to sulfuric acid.

FIG. 2 illustrates a similar flowsheet, but where the nickel and cobalt recovery includes a resin-in-pulp recovery step.

### DESCRIPTION

In a preferred embodiment, the source of magnesium sulfate is a brine that is associated with a nickel and cobalt recovery refinery, where the nickel and cobalt ore is subjected to a sulfuric acid leach process, and it will be convenient to describe the invention in relation to such a process. Generally, in such processes the nickel and cobalt recovery will include one or more steps where one or more of iron, aluminium, nickel, cobalt and manganese are precipitated, generally as hydroxides by adding a neutralising agent such as a magnesium containing alkali to a pregnant leach solution containing such species. Preferably, the magnesium containing alkali will be selected from magnesium oxide, magnesium hydroxide, magnesium carbonate or dolomite. In such a precipitation process, the magnesium would generally dissolve and report as a solution of magnesium sulfate, and be discarded as a by-product brine.

In another source of magnesium, the nickel and cobalt containing ores generally would include significant quantities of magnesium, particularly from the magnesium minerals such as serpentine associated with the saprolitic components of laterite ore or saprock. This magnesium content is generally leached together with the desired nickel and cobalt ions with the sulfuric acid, but is discarded as magnesium sulfate in the brine.

However, in order to reduce the magnesium sulfate to magnesium oxide, the magnesium sulfate should be in solid form, preferably in the form of crystalline salts. Therefore, in a preferred embodiment, in order to recover the magnesium sulfate as a solid form, concentrated sulfuric acid may be added to a magnesium sulfate containing brine to salt out the magnesium sulfate as solid crystals. The solid magnesium sulfate crystals may then be converted to magnesium oxide with sulfur dioxide produced as a by-product and incorporated into the nickel and cobalt recovery process.

Alternatively the magnesium sulfate may be crystallised from the brine by means such as evaporative crystallisation.

The nickel and cobalt recovery process is preferably either a pressure acid leach, an atmospheric pressure leach, an ammoniacal leach or a heap leach process. Most preferably the process is applicable to processing laterite ore under atmospheric pressure or heap leach conditions, however it should be understood that the processing of other metals containing ores is contemplated within the invention where the process results in the production of at least some magnesium sulfate in solution.

In a heap leach process, the sulfuric acid is allowed to percolate through one or more heaps of laterite ore to produce a leach liquor. Generally, a counter current system may be established wherein the leach liquor from a first heap is used to leach a second heap to ensure adequate build-up of the species leached.

In a preferred embodiment applicable to either the heap leach or atmospheric leach process, the leach liquor may be recycled to build up the levels of magnesium in the final or resultant leach liquor. Recycling the leach liquor also builds up the level of desired species including nickel and cobalt. Preferably, the concentration of magnesium in the resultant leach liquor is at a level of greater than 20 g/L, which is sufficient to make it feasible to salt out the resultant magnesium sulfate in solution to produce solid magnesium sulfate crystals by the addition of sulfuric acid.

The solid magnesium sulfate is recovered as hydrated crystals from the solution containing magnesium sulfate by partial or complete salting of the solution with sulfuric acid. Preferably, the sulfuric acid used in this process is in excess of 100 g/L. Further concentrated sulfuric acid may then be used in a dehydration step to dehydrate the crystals to produce substantially dehydrated magnesium sulfate crystals and residual diluted sulfuric acid. The residual diluted sulfuric acid may then be recycled to either the salting process or back to the nickel and cobalt recovery process for use in the leaching process.

The sulfuric acid solution remaining after partial or complete salting out of the magnesium sulfate may also be recycled for use in leaching in the nickel and cobalt recovery process.

The crystalline solid magnesium sulfate is then reduced with elemental sulfur in a reducing atmosphere. Preferably the reducing atmosphere is a furnace where the temperatures are elevated to be in excess of 600° C., more preferably in excess of 750° C. and most preferably in the range of from 750° C. to 850° C. Preferably, the elevated temperature is achieved by the combustion of elemental sulfur with an oxygen containing gas. Preferably the residence time with the elemental sulfur is from 5 seconds to 6 hours with a preferred residence time of from 30 seconds to 3 hours.

Generally, solid magnesium sulfate is reduced to solid magnesium oxide by elemental sulfur according to the following equation:

4MgSO₄₍ₛ₎+S_{2(g)}→4MgO+6SO_{2(g)}

The sulfur dioxide gas recovered from the process may be used for conversion to sulfuric acid. The sulfuric acid may then be used in nickel and cobalt recovery processes or indeed in other uses.

A particular benefit of the present invention is that the magnesium oxide recovered is sufficiently reactive to be used as an alkali in nickel and cobalt recovery precipitation steps.

A further advantage of the present invention is to commercially use a source of magnesium that would otherwise be simply discarded as a waste product.

In yet a further advantage, by converting the magnesium sulfate to products such as magnesium oxide and sulfur dioxide gas, which could usefully be used in a nickel and cobalt recovery process, some environmental concerns that could result by simply discarding magnesium sulfate as a waste product are alleviated.

In another advantage, the elemental sulfur which is commonly used for the production of sulfuric acid in a sulfuric acid plant, is first used to generate heat required, and provide a reagent for, the reduction of magnesium sulfate crystals to magnesium oxide. In this respect the elemental sulfur commonly supplied to the acid plant is used twice, first for the conversion of magnesium sulfate to magnesium oxide, then for production of sulfuric acid for the purpose of leaching the laterite ore.

In an additional advantage water is recovered from the brine, by the removal from solution of magnesium sulfate, which otherwise would prevent return of the water to the leaching steps, with addition of make up sulfuric acid from the acid plant. In absence of this advantage, water would be required to be supplied to the process, and water would be rejected and lost with the brine.

The present invention will be described with reference to the figures, although it should be appreciated that the figures are intended to illustrate preferred embodiments of the present invention, and the invention should not be considered to be limited to the embodiments described herein.

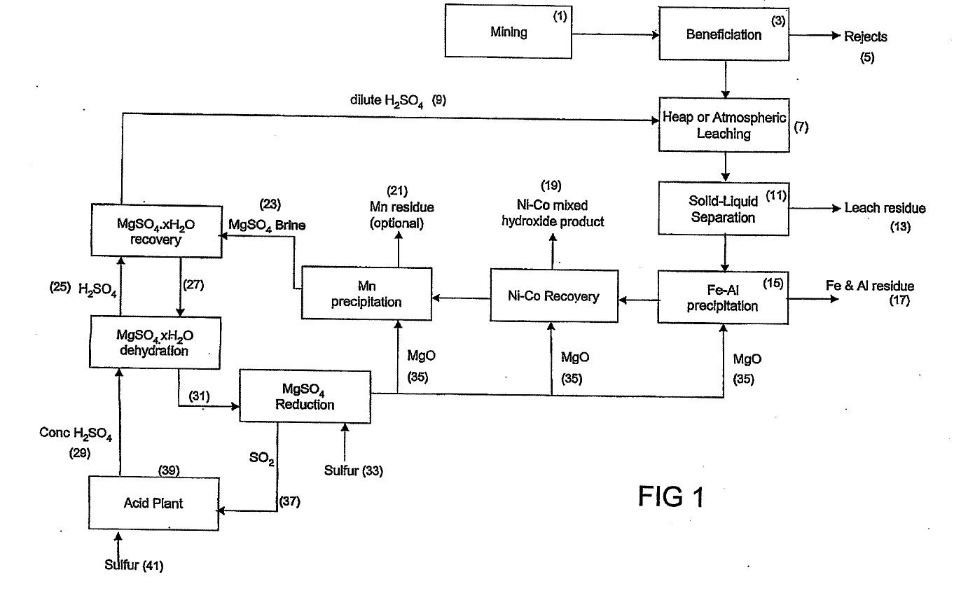

FIG. 1 illustrates an embodiment where a nickel and cobalt containing laterite ore (1), is mined and the ore body is beneficiated (3) by removing low grade or barren components (5) from the mined ore. The laterite ore itself may be separated to its saprolite and limonite components and each component treated separately or consecutively or the laterite ore may be treated as a whole.

The beneficiated ore is subjected to either heap or atmospheric leaching (7) by leaching the ore with dilute sulfuric acid (9). The leach solution is then subjected to solid/liquid separation (11) and the leach residue (13) is discarded leaving a resultant leach liquor.

The pH of the leach liquor is then raised by the addition of magnesium oxide (35) in order to precipitate out some unwanted products. Iron and aluminium will precipitate out first in a first precipitation step (15) and the iron and aluminium products are discarded as residue (17).

By the addition of further magnesium oxide, the pH of the leach liquor is raised further and nickel and cobalt will then precipitate as a mixed nickel and cobalt hydroxide product (19).

If desired, by adding yet further magnesium oxide, the pH of the leach liquor will be raised further and manganese will precipitate and is discarded as a manganese residue (21).

The magnesium contained in the magnesium oxide product will form magnesium sulfate following precipitation of the minerals as hydroxide products from the leach liquor and this magnesium sulfate would generally be discarded to a brine pond as waste solution. A further source of magnesium sulfate is from the naturally occurring magnesium in the processed ore, particularly the leaching of magnesium minerals such as serpentine, which is often present in large amounts in saprolites. The naturally occurring magnesium will leach as magnesium sulfate following the addition of sulfuric acid. Furthermore the naturally occurring magnesium will leach and report to the brine solution if magnesium containing ore is used for neutralisation purposes, such as the precipitation of iron as goethite, jarosite or hematite.

The magnesium sulfate in the brine solution (23) will generally be a hydrated product. Concentrated sulfuric acid (25) may be added to the brine solution to salt out solid crystalline magnesium sulfate (27). Further concentrated sulfuric acid (29) may be added to dehydrate the magnesium sulfate crystals to produce a solid substantially dehydrated crystalline magnesium sulfate product (31).

In a preferred form, the concentration of the acid used in the salting process is in excess of 100 g/L. A soluble organic reagent may be added to the magnesium sulfate solution to lower the solubility of the magnesium sulfate salt, therefore enabling lower concentrations of sulfuric acid to be used in the salting process. Preferable soluble organic reagents that may be used in this recovery process are methanol, ethanol, acetone or a mixture thereof. They may readily be recovered and recycled for use in the salting process if required.

The solid crystalline magnesium sulfate may then be reduced by the addition of sulfur (33) in a reducing environment, preferably a furnace at temperatures of greater than 600° C., more preferably greater than 850° C. and most preferably within the range of 750° C. to 850° C. Additional sulfur, or another fuel, may be combusted with an oxygen containing gas, such as air, to provide heat if required. This may be carried out separately from the magnesium sulfate reduction step, or in combination with it, by injection of air, and/or fuel, with the sulfur. The reduction of the solid magnesium sulfate produces magnesium oxide (35) which is of sufficient reactivity to be used as a neutralising agent in the nickel and cobalt recovery process.

The sulfur dioxide (37) can then be transferred to an acid plant (39) where the sulfur dioxide gas is converted to sulfuric acid. Additional sulfur may be combusted with air and also converted to sulfuric acid (41) if desired, as is conventional practice. This sulfuric acid can be used for a number of purposes in the nickel and cobalt recovery process, notably, it can be used in the dehydration process to remove waters of crystallisation from magnesium sulfate hydrate crystals, in the salting process to convert magnesium sulfate in solution to solid magnesium sulfate, and in addition, it can be used in the leaching process to leach the nickel and cobalt containing ore material.

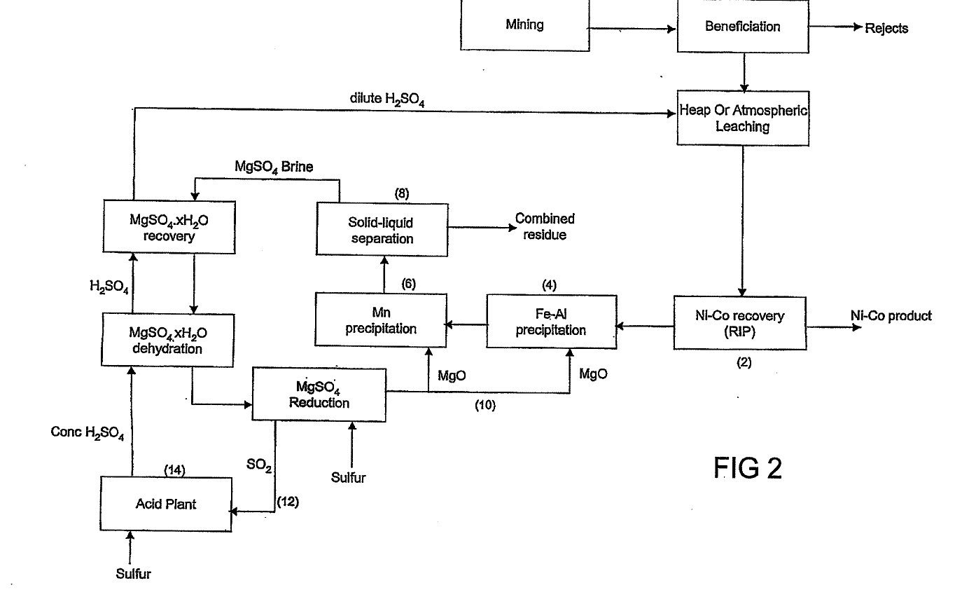

FIG. 2 illustrates an alternative embodiment where the nickel and cobalt are recovered by a resin in pulp process (2), prior to the steps of precipitation of iron and aluminium (4) and manganese (6).

Following manganese precipitation, there is a solid/liquid separation step (8) where the liquid residue containing magnesium sulfate reports to a brine pond. Solid magnesium sulfate is then recovered from the brine in the manner described in relation to FIG. 1. Upon reduction of the magnesium sulfate, the magnesium oxide product (10) is used in the iron and aluminium precipitation step (4) and the manganese precipitation step (6) while the sulfur dioxide (12) is transferred to an acid plant (14) for conversion to sulfuric acid.

### EXAMPLE 1

A pre-weighed amount of anhydrous MgSO₄ was placed inside a quartz reactor tube and both ends of the bed were plugged with quartz wool. The reactor tube was heated initially to ˜300° C. to drive off any moisture in the MgSO₄ bed and then to the required reaction temperature of 750-850° C. Sulfur vapour, generated by passing nitrogen through sulphur at 270° C. was passed into the reactor tube containing the MgSO₄.

The effects of reaction temperature and residence time on the conversion of MgSO₄ to MgO using a constant sulphur vapour generation temperature of 270° C. are presented in Table 1.

TABLE 1
Effect of temperature and residence time on conversion of MgSO₄ to MgO
using sulfur vapour.

| | | | Sulphur | | | |
|---|---|---|---|---|---|---|
| | | Residence | vapour | Reaction | stoichiometric | |
| | Temperature | time | passed | Time | % of sulphur | % conversion |
| Test | ° C. | (seconds) | (g) | (Hrs) | required | to MgO |
| 1 | 750 | 10 | 3.30 | 4 | 199 | 87 |
| 2 | 800 | 10 | 3.24 | 4 | 195 | 100 |
| 3 | 850 | 10 | 3.66 | 4 | 220 | 100 |
| 4 | 800 | 5 | 3.13 | 2 | 189 | 83 |
| 5 | 850 | 5 | 2.97 | 2 | 179 | 93 |

Conditions: Sulfur vapour generation temperature = 270° C., mass (MgSO₄) = 12.47 g,

The results in Table 1 demonstrate that temperature has a slight effect on MgSO₄ conversion using residence times of 5 and 10 sec, with a slight increase in conversion observed with increasing temperature at both residence times. The longer reaction time indicates a beneficial effect on completion of conversion to MgO.

### EXAMPLE 2

Table 2 indicates the effect of varying the sulphur generation temperature on the conversion of MgSO₄ to MgO. The higher sulphur generation indicates a beneficial effect on conversion but may also be associated with the higher total sulphur flow achieved.

TABLE 2
Effect of Sulfur temperature

| | | | | Sulphur | | | |
|---|---|---|---|---|---|---|---|
| | | Sulfur | Residence | vapour | Reaction | stoichiometric | |
| | Temp | temp | time | passed | Time | % of sulphur | % conversion |
| Test | ° C. | ° C. | (seconds) | (g) | (Hrs) | required | to MgO |
| 6 | 750 | 272 | 10 | 3.29 | 4 | 198 | 87.8 |
| 7 | 750 | 300 | 10 | 5.95 | 4 | 359 | 100 |

Conditions: mass (MgSO₄) = 12.47 g,

### EXAMPLE 3

The reactivity of MgO samples produced in under various conditions of the process were determined by titrating the reaction products with 0.1 M H₂SO₄ until a pH of 7 was reached. The consumption of sulfuric acid is assumed to be dependent on the amount of MgO in the reaction products. The results are indicated in Table 3.

TABLE 3
Reactivity of MgO produced.

| | | | 0.1M H₂SO₄ |
|---|---|---|---|
| | Weight (g) | 0.1 M H₂SO₄ | consumed |
| MgO sample source- | of reaction | consumed | per g of |
| process conditions used | product(s) | (mL) | MgO (mL) |
| Pure commercially | 0.2056 | 43.3 | 211 |
| supplied MgO | | | |
| Temp 850° C., Reaction | 0.1974 | 45.6 | 231 |
| time 4 h, Residence time | | | |
| 10 sec, Sulfur temp: 275 C. | | | |
| 800° C., 4 h, 10 sec, S: | 0.1999 | 44.1 | 221 |
| 275 C. | | | |
| 750° C., 4 h, 10 sec, | 0.226 | 48.4 | 214 |
| S: 300 C. | | | |

Example 3 shows that the MgO samples created by the process of the invention have a high reactivity and are comparable or superior to the reactivity of a commercial MgO which may be used as a neutralising agent in Ni and Co recovery operations.

The above description is illustrative of the ambit of this invention with reference to the preferred embodiment. Variation without departing from the spirit or ambit of the invention should be considered to also form part of the invention described herein.

1. A process of recovering magnesium oxide from a source of magnesium sulfate, said process including the steps of:
(a) providing a source of magnesium sulfate in solution that is derived from part of a process associated with the leaching of a metal containing ore or concentrate;
(b) converting the magnesium sulfate in solution to solid magnesium sulfate;
(c) contacting the solid magnesium sulfate with elemental sulfur in a reducing atmosphere; and
(d) recovering the magnesium as magnesium oxide, and the sulfur as sulfur dioxide gas.

2. A process according to claim 1 wherein the magnesium sulfate solution is derived from part of a nickel and cobalt recovery process.

3. A process according to claim 2 wherein the source of magnesium sulfate in solution is a brine solution.

4. A process according to claim 3 wherein the brine solution is produced as part of a nickel and cobalt recovery process where the nickel and cobalt recovery process includes the step of leaching magnesium containing minerals within nickel and cobalt containing ores with sulfuric acid.

5. A process according to claim 4 wherein the magnesium containing minerals within the nickel and cobalt containing ores is the magnesium containing minerals within the saprolitic fraction of a laterite ore or saprock.

6. A process according to claim 4 wherein the nickel and cobalt recovery process includes one or more steps of precipitation of iron, aluminium, nickel, cobalt and/or manganese by adding a magnesium containing alkali to precipitate the iron, aluminium, nickel, cobalt and/or manganese as a hydroxide.

7. A process according to claim 6 wherein the magnesium from the magnesium containing alkali is discarded as a by-product following the one or more precipitation steps.

8. A process according to claim 6 wherein the magnesium containing alkali is selected from magnesium oxide, magnesium hydroxide, magnesium carbonate or dolomite.

9. A process according to claim 1 wherein the solid magnesium sulfate is in the form of crystalline salts.

10. A process according to claim 1 wherein the solid magnesium sulfate is recovered as hydrated crystals from the solution containing magnesium sulfate by partial or complete salting of the solution with sulfuric acid in a salting process.

11. A process according to claim 10 wherein the concentration of the sulfuric acid used in the salting process is in excess of about 100 g/L.

12. A process according to claim 10 wherein concentrated sulfuric acid is used in a dehydration step to dehydrate the crystals to produce substantially dehydrated magnesium sulfate crystals and residual diluted sulfuric acid.

13. A process according to claim 12 wherein the residual diluted sulfuric acid is recycled to either the salting process and/or to the process of leaching the metal containing ore or concentrate.

14. A process according to claim 13 wherein the sulfuric acid solution remaining after partial or complete salting out of the magnesium sulfate is recycled for use in the process of leaching the metal containing ore or concentrate.

15. A process according to claims 13 wherein the process of leaching the metal containing ore is a nickel and cobalt recovery process that utilises sulfuric acid to leach nickel and cobalt containing laterite ores.

16. A process according to claim 1 wherein the solid magnesium sulfate is reduced with elemental sulfur at an elevated temperature.

17. A process according to claim 16 wherein the elevated temperature is in excess of about 600° C.

18. A process according to claim 16 wherein the elevated temperature is in excess of about 750° C.

19. A process according to claim 16 wherein the elevated temperature is in the range of from about 750° C. to about 850° C.

20. A process according to claim 16 wherein the elevated temperature is achieved by the combustion of elemental sulfur with an oxygen containing gas.

21. A process according to claim 16 wherein a residence time of contact with the elemental sulfur is from about 5 seconds to about 6 hours.

22. A process according to claim 21 wherein a residence time of contact with the elemental sulfur is from about 30 seconds to about 3 hours.

23. A process according to claim 1 wherein the reducing atmosphere is within a furnace.

24. A process according to claim 1 wherein the sulfur dioxide gas recovered from the process is used for conversion to sulfuric acid.

25. A process according to claim 1 wherein the magnesium oxide recovered is sufficiently reactive to be used as an alkali for the efficient precipitation of nickel and cobalt from solutions produced by acid leaching of laterite ores.
